(19) United States
(12) Patent Application Publication
(10) Pub. No.: US 2015/0354382 A1
(43) Pub. Date: Dec. 10, 2015

(54) EXHAUST FRAME COOLING VIA STRUT COOLING PASSAGES

(71) Applicant: General Electric Company, Schenectady, NY (US)

(72) Inventors: Srinivas PAKKALA, Chintalapudi (IN); Christopher Paul COX, Greenville, SC (US)

(21) Appl. No.: 14/297,917

(22) Filed: Jun. 6, 2014

(51) Int. Cl. F01D 9/06

(52) U.S. Cl. CPC F01D 9/065; F05D 2220/32

(57) ABSTRACT

A system is provided including a turbine exhaust section. The turbine exhaust section includes an exhaust flow path. The turbine exhaust section also includes an outer structure having an outer casing, an outer exhaust wall disposed along the exhaust flow path, and an outer cavity disposed between the outer exhaust wall and the outer casing. The turbine exhaust section further includes an inner structure having an inner exhaust wall disposed along the exhaust flow path, a bearing cavity disposed between the inner casing and a bearing housing. In addition, the turbine exhaust section includes a strut extending between the outer structure and the inner structure. The strut includes a first flow passage configured to flow a fluid from the bearing cavity to the outer cavity. The flow of fluid is thermally insulated from the strut.

### FIELD OF THE INVENTION

This invention relates generally to gas turbine cooling, and more particularly to exhaust section cooling.

### BACKGROUND OF THE INVENTION

A gas turbine engine combusts a mixture of fuel and compressed air to generate hot combustion gases which drive turbine blades thereby producing energy. The rotation of the turbine blades causes rotation of a shaft supported by bearings. The rotation of the shaft generates a significant amount of heat in the bearings. Additionally, the hot combustion gases exiting through the turbine exhaust section transfer heat to the turbine exhaust section components. Unfortunately, without adequate cooling in the turbine exhaust section, this heat may cause damage to the turbine components. Additionally, a problem that may arise in cooling systems results from the high tensile stress that is exerted on the struts of the turbine exhaust section. Such stress may cause the struts to separate from an inner structure of the turbine exhaust system.

### BRIEF SUMMARY OF THE INVENTION

One aspect of the disclosed technology relates to a strut that includes a first flow passage configured to convey a cooling airflow from a bearing cavity to an outer cavity of a turbine exhaust section.

Another aspect of the disclosed technology relates to a thermal barrier being provided between the cooling airflow and the strut to thermally insulate the airflow from the strut.

One exemplary but nonlimiting aspect of the disclosed technology relates to a system for a gas turbine comprising a turbine exhaust section including an exhaust flow path; an outer structure including an outer casing, an outer exhaust wall disposed along the exhaust flow path, and an outer cavity disposed between the outer exhaust wall and the outer casing; an inner structure including an inner exhaust wall disposed along the exhaust flow path, and a bearing cavity disposed between the inner casing and a bearing housing; a strut extending between the outer structure and the inner structure, the strut including an inner body that is load bearing and an outer body, the strut including a first flow passage configured to convey a first flow of fluid from the bearing cavity to the outer cavity; and a thermal barrier between the inner body of the strut and the first flow to prevent heat transfer from the inner body to the first flow.

Another exemplary but nonlimiting aspect of the disclosed technology relates to a system for a gas turbine comprising a turbine exhaust section including: an exhaust flow path; an outer structure including an outer casing, an outer exhaust wall disposed along the exhaust flow path, and an outer cavity disposed between the outer exhaust wall and the outer casing; an inner structure including an inner exhaust wall disposed along the exhaust flow path, and a bearing cavity disposed between the inner casing and a bearing housing; and a strut extending between the outer structure and the inner structure, the strut including an inner body that is load bearing and an outer body, the inner body including a plurality of strut holes therethrough forming a first flow passage configured to convey a first flow of fluid from the bearing cavity to the outer cavity.

Other aspects, features, and advantages of this technology will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various examples of this technology. In such drawings:

FIG. 1 is a schematic flow diagram of an example turbine system having a gas turbine engine that may employ exhaust section cooling in accordance with an example of the disclosed technology;

FIG. 2 is a perspective view of an example exhaust section of a turbine system;

FIG. 3 is a cross-sectional side view of the exhaust section of FIG. 2 illustrating exhaust section cooling in accordance with an example of the disclosed technology;

FIG. 4 is a cross-sectional view along the line 4-4 in FIG. 3;

FIG. 5 shows an enlarged detail of a cross-section of an example strut of the disclosed technology having a tubular member inserted therein;

FIG. 6 is a cross-sectional view of the inner body of an example strut;

FIG. 7 is an enlarged detail of the inner body of FIG. 6 showing a portion of the inner body near an outer structure of the exhaust section;

FIG. 8 is an enlarged detail of the inner body of FIG. 6 showing a portion of the inner body near an inner structure of the exhaust section;

FIG. 9 is a perspective view of an example tubular member of the disclosed technology;

FIG. 10 is an enlarged detail of the tubular member of FIG. 9 showing a flange portion of the tubular member;

FIG. 11 is an enlarged detail of the tubular member of FIG. 9 showing a circumferential protrusion on an outer wall of the tubular member; and

FIG. 12 is an enlarged detail of the tubular member of FIG. 9 showing a protrusion segment on an outer wall of the tubular member.

### DETAILED DESCRIPTION OF THE ILLUSTRATED EMBODIMENTS

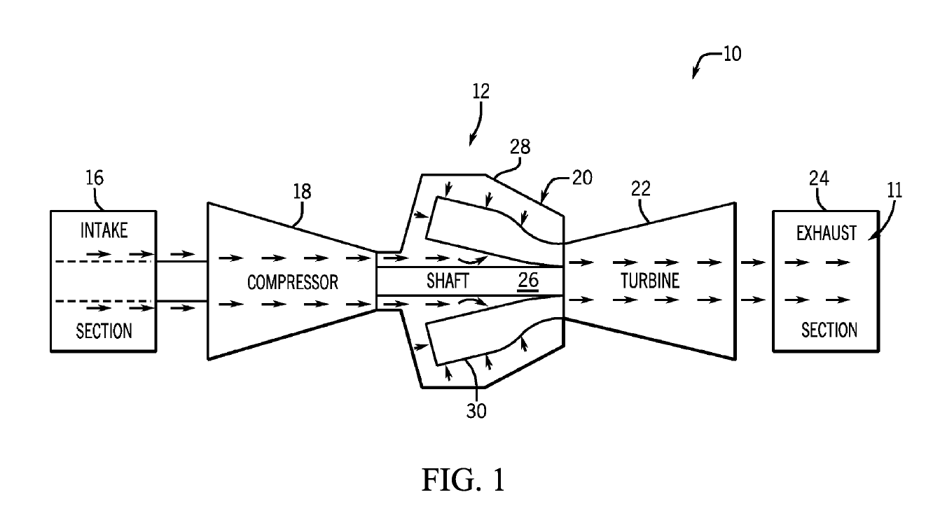

Referring to FIG. 1, a schematic flow diagram of an example turbine system 10 is shown. The turbine system 10 has a gas turbine engine 12 that may employ exhaust section cooling. For example, the system 10 may include an exhaust section cooling system 11 having one or more cooling flow paths through an exhaust section strut. In certain examples, the turbine system 10 may include an aircraft, a locomotive, a power generation system, or combinations thereof.

The illustrated gas turbine engine 12 includes an air intake section 16, a compressor 18, a combustor section 20, a turbine 22, and an exhaust section 24, as shown in FIG. 1. The turbine 22 is coupled to the compressor 18 via a shaft 26. As indicated by the arrows, air may enter the gas turbine engine 12 through the intake section 16 and flow into the compressor 18, which compresses the air prior to entry into the combustor section 20.

The illustrated combustor section 20 includes a combustor housing 28 disposed concentrically or annularly about the shaft 26 between the compressor 18 and the turbine 22. The compressed air from the compressor 18 enters combustors 30, where the compressed air may mix and combust with fuel within the combustors 30 to drive the turbine 22. From the combustor section 20, the hot combustion gases flow through the turbine 22, driving the compressor 18 via the shaft 26. For example, the combustion gases may apply motive forces to turbine rotor blades within the turbine 22 to rotate the shaft 26. After flowing through the turbine 22, the hot combustion gases may exit the gas turbine engine 12 through the exhaust section 24. As described below, the exhaust section 24 may include a plurality of struts, each having one or more cooling flow paths of the exhaust section cooling system 11.

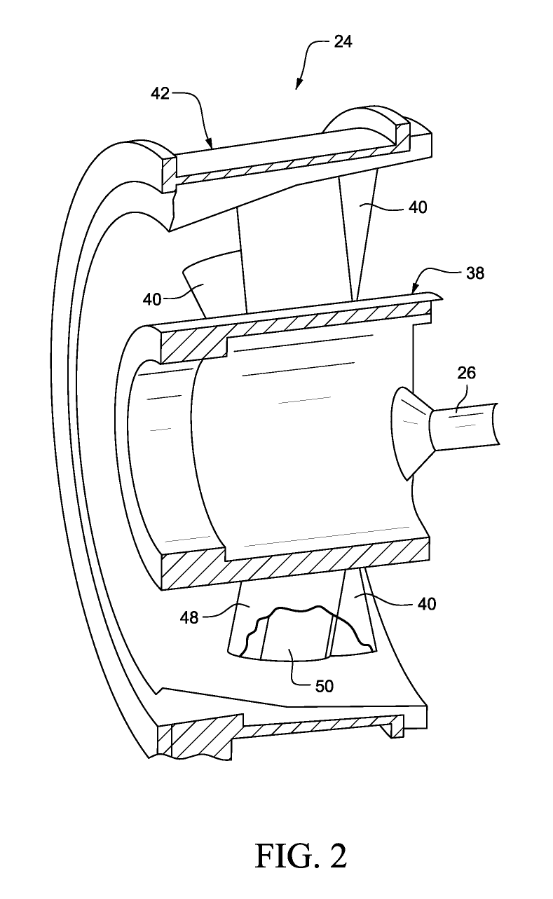

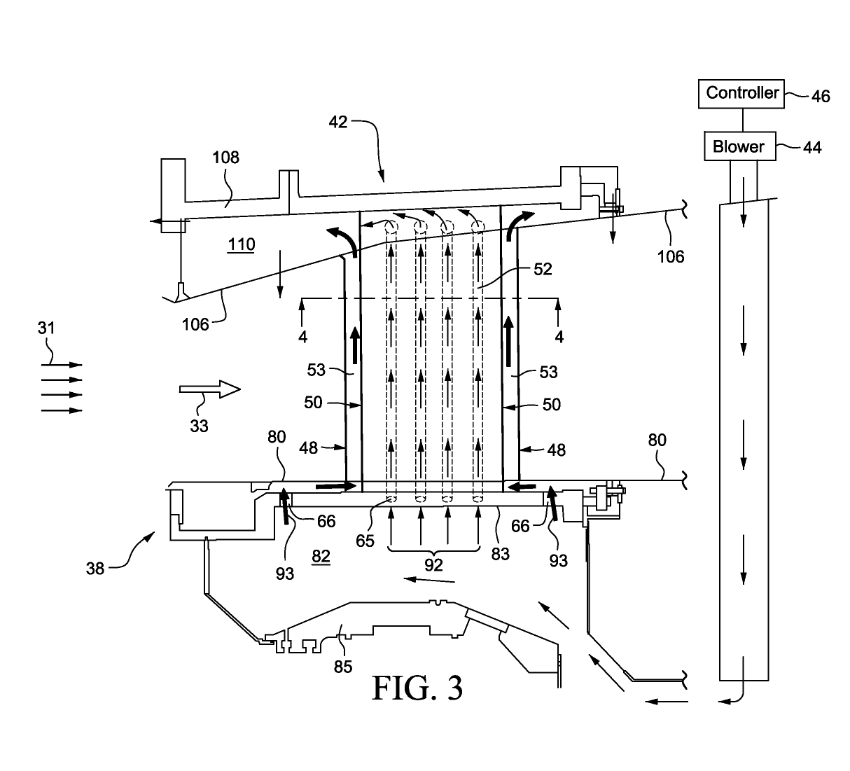

The exhaust section 24 may include an inner structure (i.e., inner barrel) 38, at least one strut 40, and an outer structure (i.e., outer barrel) 42, as shown in FIG. 2. The strut 40 provides support between the outer structure 42 and the inner structure 38. As the hot combustion gases exit the turbine 22 and the shaft 26 rotates, the components in the exhaust section 24 may experience high temperature conditions. More specifically, the high temperature conditions may cause thermal stress, wear, and/or damage to the strut 40, the inner structure 38, and the outer structure 42. Accordingly, the exhaust section cooling system 11 may include a blower 44 coupled to a controller 46 which controls a cooling air flow through the inner structure 38, the strut 40, and the outer structure 42 to reduce thermal stress and wear of these components and parts disposed therein, as shown in FIG. 3.

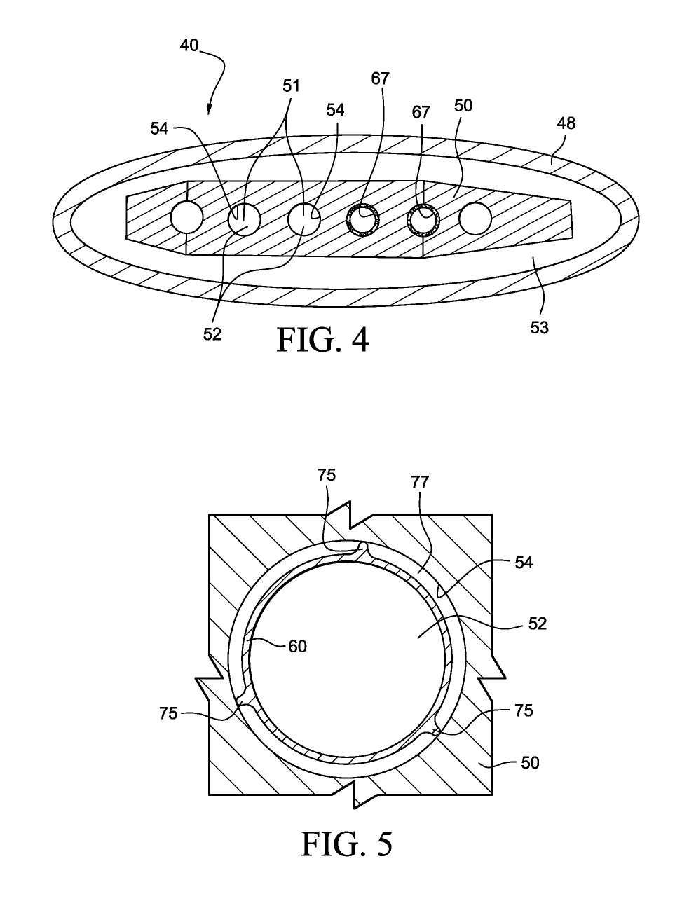

Referring to FIGS. 2-4 the strut 40 includes an outer body 48 and an inner body 50. The inner body 50 defines a first flow passage 52 (e.g., inner flow passage) for conveying a first flow 92 and the outer body 48 may define a second flow passage 53 (e.g., outer flow passage) for conveying a second flow 93 of the exhaust section cooling system 11. The first flow passage 52 is formed by a plurality of strut holes 51 which extend through the inner body 50 from the inner structure 38 to the outer structure 42, as shown in FIG. 4. In an example, each strut 40 may include six strut holes 51 (each having, for example, a 1.5 inch diameter). The second flow passage 53 is formed by a space between the inner body and the outer body 48.

In the illustrated example, the inner body 50 of the strut 40 is a load bearing structural support configured to bear a considerable mechanical load between the inner and outer structures 38 and 42 of the exhaust section 24, while the outer body 48 of the strut 40 is not a load bearing structural support. For example, the outer body 48 may be included to protect the inner body 50 by blocking heat from the inner body 50. In particular, the outer body 48 may be designed to flow cooling air externally along the inner body 50 to provide a thermal barrier between the inner body 50 and the hot combustion gases 31 in the exhaust section 24, as shown in FIG. 3. In an example, the inner body 50 may be made of carbon steel whereas the outer body 48 may be stainless steel.

The outer body 48 also may have greater thermal resistance to the hot combustion gases 31 as compared to the inner body 50. For example, the inner body 50 may have a lower temperature limit than the outer body 48. In some embodiments, the inner body 50 may have a temperature limit lower than the temperature of the hot combustion gases 31, while the outer body 48 may have a temperature limit substantially above the temperature of the hot combustion gases. Thus, the outer body 48 thermally protects the inner body 50, such that the inner body 50 is able to effectively bear the mechanical load between the inner and outer structures 38 and 42 of the exhaust section 24.

Referring to FIG. 3, the inner structure 38 defines an inner exhaust wall 80, a bearing cavity 82, a bearing assembly (not shown) housed in a bearing housing 85, and an inner casing 83. The outer structure 42 includes an outer exhaust wall 106 and an outer casing 108, which define an intermediate outer cavity 110 (e.g., an annular space). The first flow 92 enters the first flow passage 52 through first openings 65 formed in the inner casing 83. The second flow 93 enters the second flow passage 53 through second openings 66 formed in the inner casing 83.

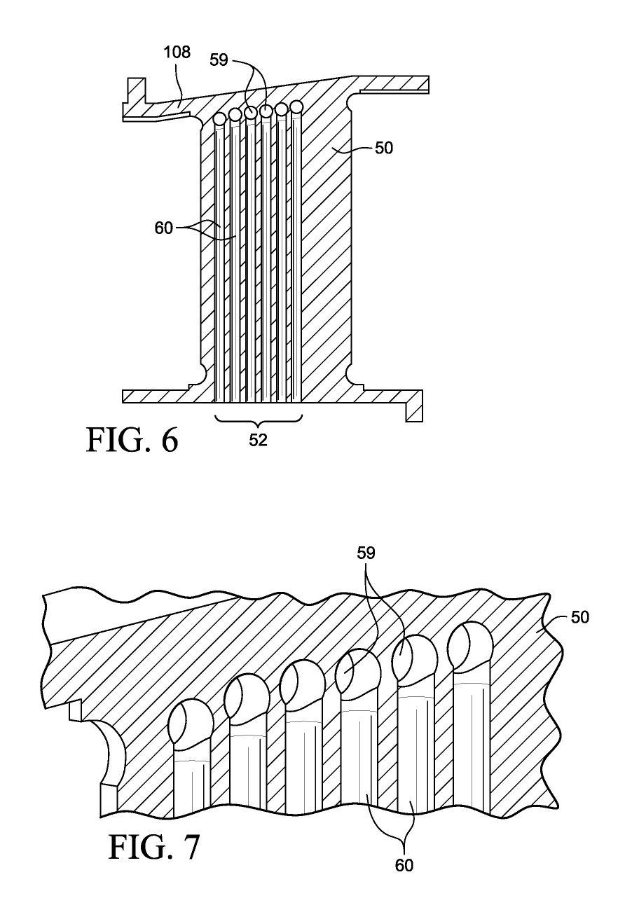

As the first and second flows 92, 93 exit the strut 40, they enter the outer cavity 110 for controlling the temperature of the outer structure 42 before venting into the exhaust flow path 33, as shown in FIG. 3. The first flow 92 is directed away from the inner body 50 via cross holes 59 which are formed in the inner body 50, as shown in FIG. 6. The cross holes 59 may, for example, have a 1.75 inch diameter. The first and second flows 92, 93 eventually vent into the exhaust flow path 33 through apertures (not shown) in the outer structure 42 (e.g., the outer exhaust wall 106).

As shown in FIG. 4, the outer body 48 may have an oval shape (e.g., an airfoil shape), while the inner body 50 is generally rectangular with tapered end portions. In other examples, the inner and outer bodies 50 and 48 may have other shapes, for example rectangular in rectangular, airfoil in airfoil, oval in oval, etc. Regardless of the particular shapes, the inner and outer bodies 50 and 48 are disposed one inside another, such that the first and second flow passages 52 and 53 are isolated one inside another (e.g., coaxial).

As shown in FIG. 4, the strut holes 51 have inner walls 54. A problem that may arise results from the high tensile stress that is exerted on the inner body 50. Such stress may cause a flange of the inner body 50 at the inner structure 38 to open (or pull away from the inner structure 38). This stress may be reduced by providing a thermal barrier between the inner wall 54 and the first flow 92 so as to reduce the heat transfer from the inner body 50 to the first flow 92. That is, when the inner body 50 is kept at higher temperatures, the inner body 50 tends to be in compression which reduces the tensile stress.

In an example, the inner walls 54 may be coated with a thermal insulation coating 67 to provide a thermal barrier between the inner walls 54 and the first flow, as shown in FIG. 4. The thermal insulation coating 67 may be provided to any number of the strut holes 51, e.g., the thermal insulation coating 67 may be provided to two strut holes while the other strut holes are not provided with a thermal barrier, as shown in FIG. 4. Of course, the thermal insulation coating 67 may be provided to each strut hole 51.

In another example, the strut holes 51 may be provided with an inserted tubular member 60, as shown in FIGS. 5-8. The tubular member 60 is positioned with respect to the inner walls 54 of the strut holes 51 so as to form a gap 77 therebetween. Each tubular member 60 may include a plurality of protrusion segments 75 on an outer wall 64 thereof to space the outer wall 64 from the inner wall 54 of the strut hole 51. The gaps 77 are filled with gas (e.g., air) which functions to insulate the first flow 92 (which passes through the tubular members 60) from the inner walls 54 of the inner body 50 thereby forming a thermal barrier between the first flow 92 and the inner walls 54.

The tubular members 60 may be provided to any number of the strut holes 51, e.g., the tubular members 60 may be provided to all strut holes, as shown in FIGS. 6 and 7. Of course, the tubular members 60 may be provided to only a portion of the strut holes 51.

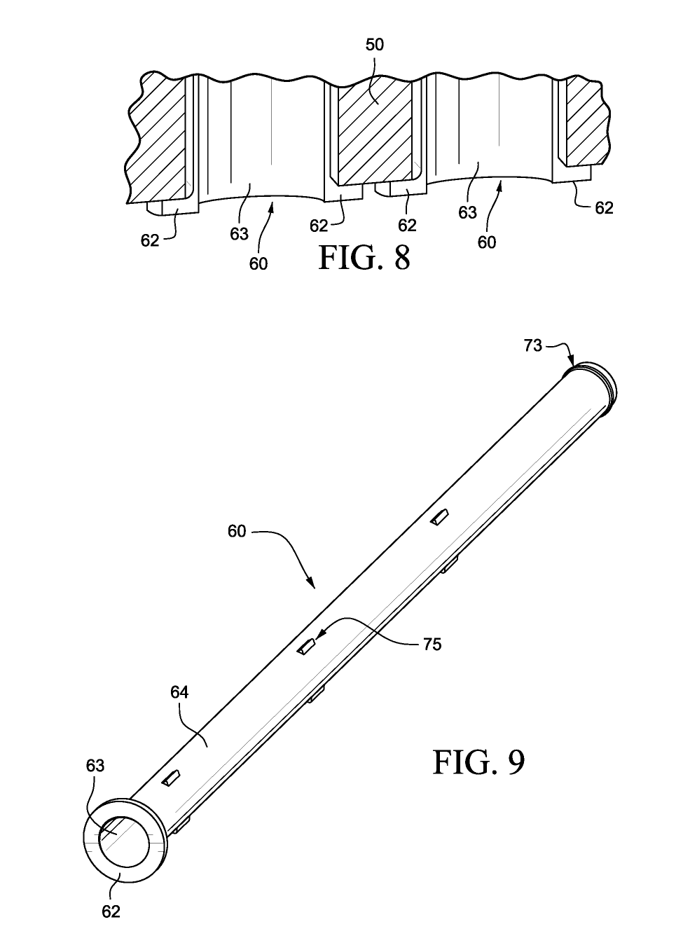

As shown in FIGS. 6 and 7, the tubular members 60 terminate before the cross holes 59. Referring to FIGS. 8 and 9, the inner wall 63 of the tubular member 60 forms a hollow portion through which the first flow passes. At the inner structure 38, each tubular member 60 is attached to the inner body 50 by a flange 62 which protrudes from an end of the tubular member and abuts against an end of the inner body 50. The flange 62 may be attached to the inner structure 38 via dowel pins and a weld joint. This connection seals the tubular member 60 with the inner structure 38.

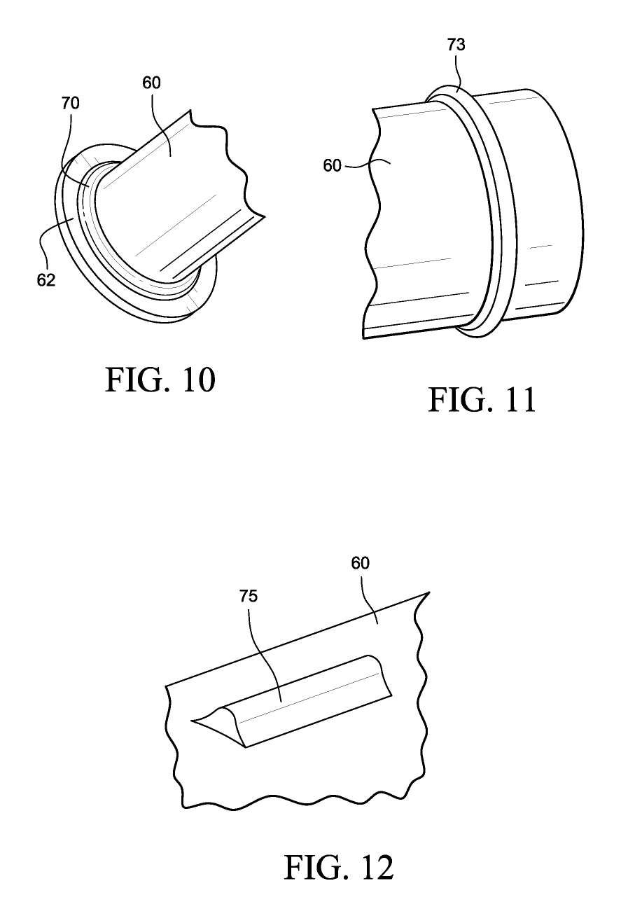

As shown in FIG. 10, the flange 62 may be attached to the outer wall 64 of the tubular member 60 by a joint 70 (e.g., a weld joint). The protrusion segments 75 also provide support for the tubular member 60 and may be arranged on the outer wall 64 of the tubular member 60 in a spaced arrangement, as shown in FIG. 9. The position of the protrusion segments 75 on the outer wall 64, the number of protrusion segments, and the size of the protrusion segments may vary according to the size of the strut 40 as well as other factors, as those skilled in the art will understand.

As shown in FIGS. 9 and 11, a circumferential protrusion 73 may be wrapped around the outer wall 64 near an end of the tubular member 60 arranged at the outer structure 42. The circumferential protrusion 73 provides support for the tubular member 60 and also seals the gap 77 between the inner wall 54 of the strut hole and the outer wall 64 of the tubular member 60. The circumferential protrusion 73 may be welded to the outer wall 64 of the tubular member 60.

As shown in FIG. 3, the cooling air may be introduced at or near a downstream location of the exhaust section 24 by the blower 44. In other words, some of the cooling air may be introduced into the inner structure 38 downstream of the strut 40 and the bearing assembly, among other components of the exhaust section 24. Portions of the cooling air blown into the inner structure 38 circulate through the inner structure 38 (e.g., across the bearing housing 85), and then exit through the first and second flow passages 52, 53 of the strut 40 and into the outer structure 42 for venting into the exhaust path 33.

The source of the cooling air 58 may be the compressor 18 of the gas turbine engine 12 or some other external air source.

A controller 46 may be configured to actively control the operation of the blower 44 and other components of the exhaust section cooling system 11. The controller 46 may include a processor, which may read from and write to a memory, such as a non-transitory, computer-readable medium (e.g., a hard drive, flash drive, random access memory (RAM), compact disc (CD), and so forth), having computer instructions encoded thereon, which are configured to perform active control operations. More specifically, the controller 46 may be configured to receive signals relating to operating parameters of the exhaust section cooling system 11 (e.g., signals relating to temperatures in and around the struts 40, the flow passages 52, 53, the bearing housing 85, the bearing cavity 82, and so forth) and to generate and transmit control signal for the blower 44.

While the invention has been described in connection with what is presently considered to be the most practical and preferred examples, it is to be understood that the invention is not to be limited to the disclosed examples, but on the contrary, is intended to cover various modifications and equivalent arrangements included within the spirit and scope of the appended claims.

What is claimed is:

1. A system for a gas turbine, comprising:
a turbine exhaust section, including:
an exhaust flow path;
an outer structure including an outer casing, an outer exhaust wall disposed along the exhaust flow path, and an outer cavity disposed between the outer exhaust wall and the outer casing;
an inner structure including an inner exhaust wall disposed along the exhaust flow path, and a bearing cavity disposed between the inner casing and a bearing housing;
a strut extending between the outer structure and the inner structure, the strut including an inner body that is load bearing and an outer body, the strut including a first flow passage configured to convey a first flow of fluid from the bearing cavity to the outer cavity; and
a thermal barrier between the inner body of the strut and the first flow to thermally insulate the first flow from the inner body.

2. The system of claim 1, wherein the inner body of the strut includes a plurality of strut holes therethrough, the plurality of strut holes forming the first flow passage.

3. The system of claim 2, wherein the thermal barrier comprises a thermal insulation coating on inner walls of at least two of the strut holes.

4. The system of claim 3, wherein the thermal insulation coating is provided on the inner walls of each of the strut holes.

5. The system of claim 2, further comprising tubular members respectively installed in at least two of the strut holes to pass the first flow through a hollow portion of each tubular member.

6. The system of claim 5, wherein an outer wall of each tubular member is spaced from a respective inner wall of a respective strut hole to form a gap therebetween.

7. The system of claim 6, wherein a gas occupies the gap and forms the thermal barrier.

8. The system of claim 6, wherein each outer wall of the tubular members includes a plurality of protrusion segments arranged to engage the respective inner wall of the respective strut hole to form the gap.

9. The system of claim 1, wherein the outer body is not load bearing.

10. The system of claim 1, further comprising a blower to supply a flow of fluid to the bearing cavity.

11. The system of claim 1, wherein the outer exhaust wall comprises a plurality of openings configured to flow the first flow of fluid from the outer cavity into the exhaust flow path.

12. A system for a gas turbine, comprising:
a turbine exhaust section, including:
an exhaust flow path;
an outer structure including an outer casing, an outer exhaust wall disposed along the exhaust flow path, and an outer cavity disposed between the outer exhaust wall and the outer casing;
an inner structure including an inner exhaust wall disposed along the exhaust flow path, and a bearing cavity disposed between the inner casing and a bearing housing; and
a strut extending between the outer structure and the inner structure, the strut including an inner body that is load bearing and an outer body, the inner body including a plurality of strut holes therethrough forming a first flow passage configured to convey a first flow of fluid from the bearing cavity to the outer cavity.

13. The system of claim 12, wherein an air gap is disposed between the first flow and inner walls of the strut holes to form a thermal barrier.

14. The system of claim 12, wherein the outer body is not load bearing.

15. The system of claim 12, further comprising a blower to supply a flow of fluid to the bearing cavity.

16. The system of claim 12, wherein the outer exhaust wall comprises a plurality of openings configured to flow the first flow of fluid from the outer cavity into the exhaust flow path.

17. The system of claim 12, wherein a thermal barrier is disposed between the inner body of the strut and the first flow to prevent heat transfer from the inner body to the first flow.

18. The system of claim 17, wherein the thermal barrier comprises a thermal insulation coating on inner walls of at least two of the strut holes.

19. The system of claim 17, further comprising tubular members respectively installed in at least two of the strut holes to pass the first flow through a hollow portion of each tubular member,
wherein an outer wall of each tubular member is spaced from a respective inner wall of a respective strut hole to form a gap therebetween, and wherein a gas occupies the gap and forms the thermal barrier.

20. A gas turbine, comprising:
a compressor;
a combustor section;
a turbine section; and
the system of claim 12.
